(19) United States
(12) Patent Application Publication
(10) Pub. No.: US 2025/0205890 A1
(43) Pub. Date: Jun. 26, 2025

(54) DETERMINATION OF HOLDING POSITION ON WORKPIECE

(71) Applicant: KABUSHIKI KAISHA YASKAWA DENKI, Kitakyushu-shi (JP)

(72) Inventors: Ryo KABUTAN, Fukuoka (JP); Makoto TAKAHASHI, Fukuoka (JP)

(73) Assignee: KABUSHIKI KAISHA YASKAWA DENKI, Kitakyushu-shi (JP)

(21) Appl. No.: 18/954,718

(22) Filed: Nov. 21, 2024

(30) Foreign Application Priority Data
Dec. 21, 2023 (JP) 2023-216157

(51) Int. Cl. B25J 9/16

(52) U.S. Cl. CPC B25J 9/1664

(57) ABSTRACT

A control assistance system includes circuitry configured to: virtually execute, for each of two or more candidate positions that are two or more candidates for a holding position on a workpiece to be held by an end effector of a robot, a picking process in which the end effector holds the workpiece at the candidate position and a subsequent process for the workpiece held at the candidate position, by a simulation based on a workpiece model indicating a shape of the workpiece and a robot model indicating the robot having the end effector; and determine, as the holding position, one of at least one candidate position that enables the picking process and the subsequent process to be completed in the simulation.

### CROSS-REFERENCE TO RELATED APPLICATIONS

This application is based upon and claims the benefit of priority from Japanese Patent Application No. 2023-216157, filed on Dec. 21, 2023, the entire contents of which are incorporated herein by reference.

### BACKGROUND

### Field

One aspect of the present disclosure relates to a control assistance system, a control assistance method, and a control assistance program.

### Background Art

### Description of the Related Art

Japanese Unexamined Patent Application Publication No. 2022-181174 describes a robot system for picking up one object from a group of objects using a robot. The system includes a camera that provides an image of an object, a deep learning neutral network that generates a segmented image of the object, a means for identifying a place for picking up the object using the segmented image, and a means for rotating the object using an orientation of the object in the segmented image.

### SUMMARY

A control assistance system according to an aspect of the present disclosure includes circuitry configured to: acquire a workpiece model indicating a shape of a workpiece; acquire a robot model indicating a robot having an end effector for holding the workpiece; set, on the workpiece, two or more candidate positions that are two or more candidates for a holding position on the workpiece to be held by the end effector, based on the workpiece model; virtually execute, for each of the two or more candidate positions, a picking process in which the end effector holds the workpiece at the candidate position and a subsequent process for the workpiece held at the candidate position, by a simulation based on the workpiece model and the robot model; determine, as the holding position, one of at least one candidate position among the two or more candidate positions, wherein the at least one candidate position enables the picking process and the subsequent process to be completed in the simulation; and control the robot placed in a real working space, based on the holding position.

A processor-executable method according to an aspect of the present disclosure includes: acquiring a workpiece model indicating a shape of a workpiece; acquiring a robot model indicating a robot having an end effector for holding the workpiece; setting, on the workpiece, two or more candidate positions that are two or more candidates for a holding position on the workpiece to be held by the end effector, based on the workpiece model; virtually executing, for each of the two or more candidate positions, a picking process in which the end effector holds the workpiece at the candidate position and a subsequent process for the workpiece held at the candidate position, by a simulation based on the workpiece model and the robot model; determining, as the holding position, one of at least one candidate position among the two or more candidate positions, wherein the at least one candidate position enables the picking process and the subsequent process to be completed in the simulation; and controlling the robot placed in a real working space, based on the holding position.

A non-transitory computer-readable storage medium according to an aspect of the present disclosure stores processor-executable instructions to: acquire a workpiece model indicating a shape of a workpiece; acquire a robot model indicating a robot having an end effector for holding the workpiece; set, on the workpiece, two or more candidate positions that are two or more candidates for a holding position on the workpiece to be held by the end effector, based on the workpiece model; virtually execute, for each of the two or more candidate positions, a picking process in which the end effector holds the workpiece at the candidate position and a subsequent process for the workpiece held at the candidate position, by a simulation based on the workpiece model and the robot model; determine, as the holding position, one of at least one candidate position among the two or more candidate positions, wherein the at least one candidate position enables the picking process and the subsequent process to be completed in the simulation; and control the robot placed in a real working space, based on the holding position.

### BRIEF DESCRIPTION OF THE DRAWINGS

FIG. 1 is a diagram showing an example application of a control assistance system.

FIG. 2 is a diagram showing an example functional configuration of the control assistance system.

FIG. 3 is a diagram showing an example hardware configuration of a computer used for the control assistance system.

FIG. 4 is a flowchart showing an example process executed by the control assistance system.

FIG. 5 is a flowchart showing an example of setting candidate positions in detail.

FIG. 6 is a diagram showing an example of temporarily set candidate positions.

FIG. 7 is a diagram showing an example method of calculating a degree of contact.

FIG. 8 is a diagram showing an example series of processes for determining a holding position.

### DETAILED DESCRIPTION

In the following description, with reference to the drawings, the same reference numbers are assigned to the same components or to similar components having the same function, and overlapping description is omitted.

### Overview of System

A control assistance system according to the present disclosure is a computer system for determining a holding position on a workpiece to be held by an end effector of a robot. The control assistance system sets two or more candidate positions that are candidates for the holding position. The control assistance system then virtually executes, for each of the two or more candidate positions, a process involving holding of the workpiece at the candidate position by the robot, by a simulation. The control assistance system determines one of the two or more candidate positions as the holding position based on a result of the simulation. In the present disclosure, the fact that the robot holds the workpiece with the end effector is also simply referred to as “the robot holds the workpiece”. The holding may be realized by various methods such as gripping and suction.

Conventionally, the holding position on the workpiece is determined manually. In order to determine the holding position, it is necessary to consider various factors such as the stability of the workpiece while being held, and the processing performed after the holding. For the processing after the holding, it is necessary to meet constraints such as that the robot is able to operate for the processing and that the robot does not interfere with an obstacle. In addition, the holding position needs to be determined for each type of workpiece. For a given workpiece, the holding position may vary depending on factors such as processing after the holding and an actual surrounding environment in which the workpiece is processed. Since it is necessary to consider various factors as described above, the determination of the holding position is a difficult task.

The control assistance system determines the holding position in consideration of not only the holding of the workpiece but also the processing after the holding. By adopting the holding position in consideration also of the processing after the holding, it is not necessary to change the holding position during the period from the holding of the workpiece to the completion of subsequent processing. That is, the control assistance system may determine the holding position of the workpiece that contributes to an efficient operation of the robot.

In some examples, the control assistance system controls the robot placed in a real working space so as to hold the workpiece at the holding position, based on the determined holding position. For example, the control assistance system generates an operation program based on the holding position, and controls the real robot based on the operation program. In this way, the control assistance system may generate a series of motions of the robot involving the holding of the workpiece. By using the control assistance system, a series of robot operations including a picking process and a subsequent process following the picking process may be easily generated.

### Configuration of System

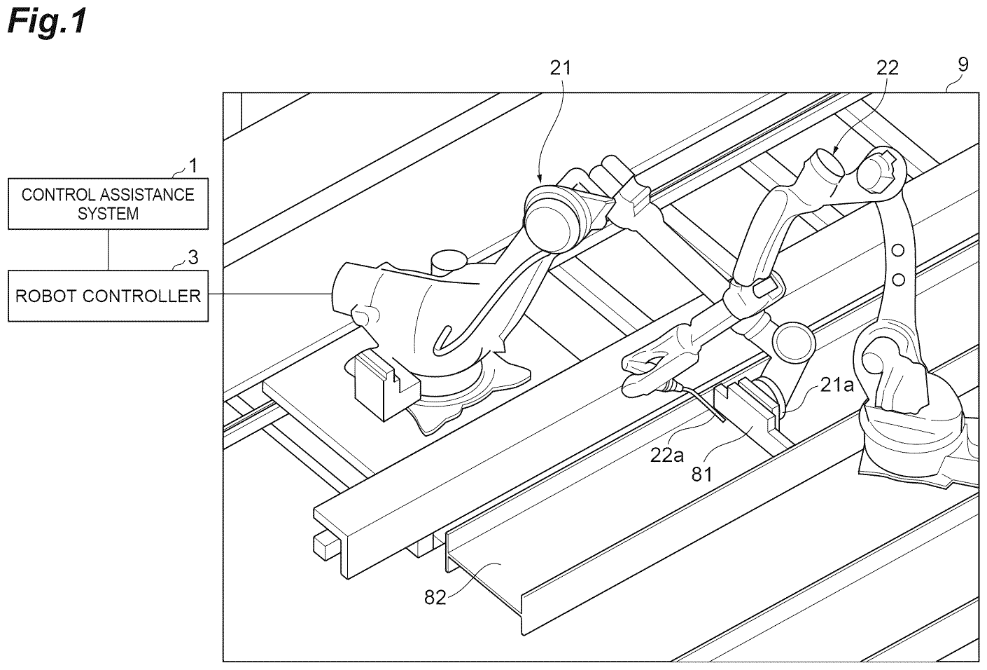

FIG. 1 is a diagram showing an example application of the control assistance system. A control assistance system 1 shown in this example determines a holding position of a real workpiece to be held by a real robot in a real working space 9. In the example of FIG. 1, a first robot 21 and a second robot 22 are placed on the working space 9, and these robots cooperate to fix a first workpiece 81 on a second workpiece 82. The second workpiece 82 is a workpiece different from the first workpiece 81. Hereinafter, it is assumed that the first robot 21 holds the first workpiece 81. Thus, the control assistance system 1 determines a holding position on the first workpiece 81 to be held by the first robot 21. The second robot 22 is an example of a different device different from the first robot 21. The different device such as the second robot 22 contributes to the processing of the workpiece, together with the robot (e.g., first robot 21) holding the workpiece. The control assistance system 1 is connected to a robot controller 3 that controls at least the first robot 21, via a communication network. The communication network may be a wired network or a wireless network. The communication network may include at least one of the Internet and an intranet. Alternatively, the communication network may be implemented simply by a single communication cable.

In the example of FIG. 1, the second workpiece 82 is an H-steel, and the first workpiece 81 is a substantially T-shaped steel to be welded to the H-steel. The first robot 21 fits the T-shaped steel into the H-steel by a pick-and-place process on the T-shaped steel, and continues to hold the T-shaped steel until the end of the welding. The second robot 22 welds the T-shaped steel fitted into the H-steel to fix the T-shaped steel to the H-steel. At least one of the first robot 21 and the second robot 22 may move on a rail provided so as to extend along the H-steel. Alternatively, at least one of the first robot 21 and the second robot 22 may be an autonomous mobile robot (AMR) or may be supported by an automated guided vehicle (AGV). The first robot 21 and the second robot 22 may move in cooperation with a positioner that holds a workpiece.

The first robot 21 is a device that receives power and performs a predetermined motion according to a purpose, thereby performing a useful work. In some examples, the first robot 21 includes a plurality of joints, an arm, and a first end effector 21a attached to a tip of the arm. The first robot 21 holds a workpiece by using the first end effector 21a. Examples of the first end effector 21a may include a gripper, a suction hand, and a magnetic hand. A joint axis is set for each of the plurality of joints. Some components of the first robot 21, such as the arm and a pivoting unit., rotate about the joint axis, so that the first robot 21 may change the position and posture of the first end effector 21a within a predetermined range. In some examples, the first robot 21 is a multi-axis serial link type vertical articulated robot. The first robot 21 may be a six-axis vertical articulated robot, or may be a seven-axis vertical articulated robot in which one redundant axis is added to six axes. As described above, the first robot 21 may be a self-propelled movable robot, for example, an autonomous mobile robot (AMR), or a robot supported by an automated guided vehicle (AGV). Alternatively, the first robot 21 may be a stationary robot fixed at a predetermined place.

In some examples, the second robot 22 has the same configuration as the first robot 21. The second end effector 22a of the second robot 22 has a function of fixing the first workpiece 81 to the second workpiece 82. Examples of the second end effector 22a may include a welding gun and a screw fastening device.

The robot controller 3 is a device that controls at least the first robot 21 in accordance with an operation program generated in advance. In some examples, the robot controller 3 calculates a joint angle target value (angle target value of each joint of the first robot 21) for matching the position and posture of an end effector with a target value indicated by the operation program, and controls the first robot 21 according to the angle target value.

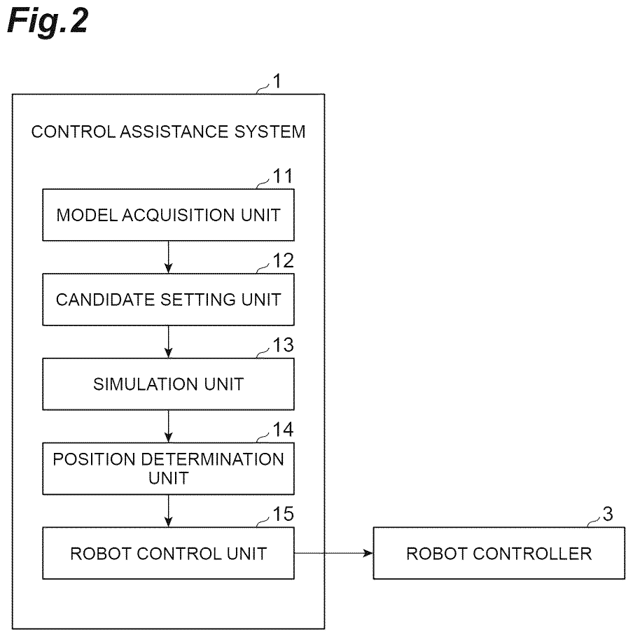

FIG. 2 is a diagram showing an example functional configuration of the control assistance system 1. In this example, the control assistance system 1 includes a model acquisition unit 11, a candidate setting unit 12, a simulation unit 13, a position determination unit 14, and a robot control unit 15 as functional elements. The model acquisition unit 11 is a functional module that acquires model data used for the simulation. The candidate setting unit 12 is a functional module that sets two or more candidate positions that are candidates for the holding position of the first workpiece 81. The simulation unit 13 is a functional module that virtually executes, for each of the two or more candidate positions, processing performed by the first robot 21 and the second robot 22 based on the candidate position, by the simulation. The simulation is a process that does not actually operate the first robot 21 and the second robot 22 placed in the working space 9, but rather virtually represents the operations of these robots on a computer. The position determination unit 14 is a functional module that determines one of the two or more candidate positions as the holding position based on a result of the simulation. The robot control unit 15 is a functional module that controls at least the first robot 21 based on the holding position.

The control assistance system 1 may be implemented by any type of computer. The computer may be a general-purpose computer such as a personal computer or a business server, or may be incorporated in a dedicated device that executes specific processing.

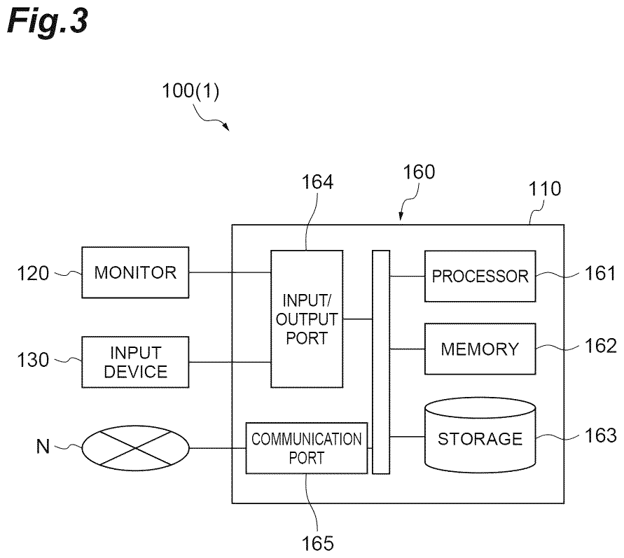

FIG. 3 is a diagram showing an example hardware configuration of a computer 100 used for the control assistance system 1. In this example, the computer 100 comprises a main body 110, a monitor 120, and an input device 130.

The main body 110 is a device having circuitry 160. The circuitry 160 has a processor 161, a memory 162, a storage 163, an input/output port 164, and a communication port 165. The number of each hardware component may be one or two or more. The storage 163 stores a program for configuring each functional module of the main body 110. The storage 163 is a computer-readable recording medium such as a hard disk, a nonvolatile semiconductor memory, a magnetic disk, or an optical disk. The memory 162 temporarily stores a program loaded from the storage 163, a calculation result of the processor 161, etc. The processor 161 configures each functional module by executing the program in cooperation with the memory 162. The input/output port 164 inputs and outputs electrical signals to and from the monitor 120 or the input device 130 in response to commands from the processor 161. The communication port 165 performs data communication with other devices such as the robot controller 3 via a communication network N in accordance with commands from the processor 161.

The monitor 120 is a device for displaying information output from the main body 110. For example, the monitor 120 is a device capable of graphic display, such as a liquid-crystal panel.

The input device 130 is a device for inputting information to the main body 110. Examples of the input device 130 include operation interfaces such as a keypad, a mouse, and a manipulation controller.

The monitor 120 and the input device 130 may be integrated as a touch panel. For example, the main body 110, the monitor 120, and the input device 130 may be integrated as a tablet computer.

Each functional module in the control assistance system 1 is implemented by loading a control assistance program on the processor 161 or the memory 162 and executing the program in the processor 161. The control assistance program includes codes for implementing each functional module of the control assistance system 1. The processor 161 operates the input/output port 164 and the communication port 165 according to the control assistance program, and executes reading and writing of data in the memory 162 or the storage 163.

The control assistance program may be provided by being recorded in a non-transitory recording medium such as a CD-ROM, a DVD-ROM, or a semiconductor memory. Alternatively, the control assistance program may be provided via a communication network as data signals superimposed on carrier waves.

### Control Assistance Method

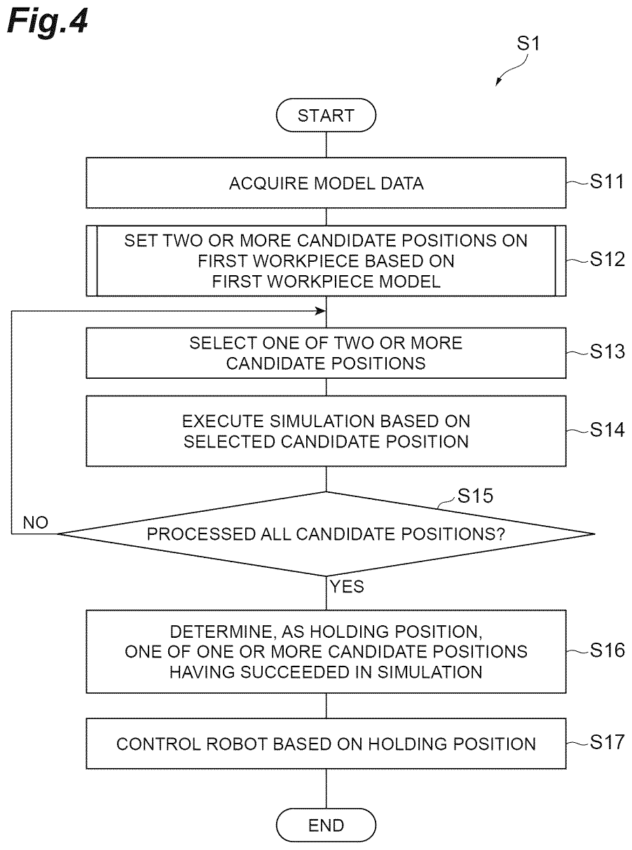

As an example of the control assistance method according to the present disclosure, an example of processing executed by the control assistance system 1 will be described with reference to FIG. 4. FIG. 4 is a flowchart showing that example as a processing flow S1. That is, the control assistance system 1 performs the processing flow S1.

In step S11, the model acquisition unit 11 acquires model data. In some examples, the model acquisition unit 11 acquires the model data including a first workpiece model indicating the first workpiece 81 and a first robot model indicating a first robot 21 having a first end effector 21a. The model acquisition unit 11 may acquire the model data further including a second workpiece model indicating the second workpiece 82 and a second robot model indicating a second robot 22 having a second end effector 22a. Both of these models are represented by electronic data. The second robot model is an example of a device model indicating a different device different from the first robot 21. A workpiece model, such as the first workpiece model and the second workpiece model, indicates at least a shape of the workpiece, and may further indicate other attributes of the workpiece, such as dimensions. A robot model, such as the first robot model and the second robot model, indicates specifications for a robot and an end effector. The specification may include parameters related to structures of the robot and the end effector, such as a shape and dimensions, and parameters related to functions of the robot and the end effector, such as a movable range of each joint and performance of the end effector.

In some examples, the model acquisition unit 11 acquires the model data designated by a user of the control assistance system 1. The model acquisition unit 11 may read the model data corresponding to the user instruction from a predetermined storage device such as the storage 163, or may receive the model data input by the user via the input device 130. In any case, in a case where the workpiece and the robot are designated by the user, the model acquisition unit 11 acquires the model data corresponding to that designation, that is, the workpiece model and the robot model corresponding to that designation. For example, in a case where the first robot 21 and the second robot 22 are able to process a plurality of types of first workpieces 81, the user may cause these robots to process the plurality of types of first workpieces 81 while changing the type of first workpiece 81. In this case, in a case where the user designates the first workpiece 81 to be processed next, the model acquisition unit 11 acquires the first workpiece model of the designated first workpiece 81.

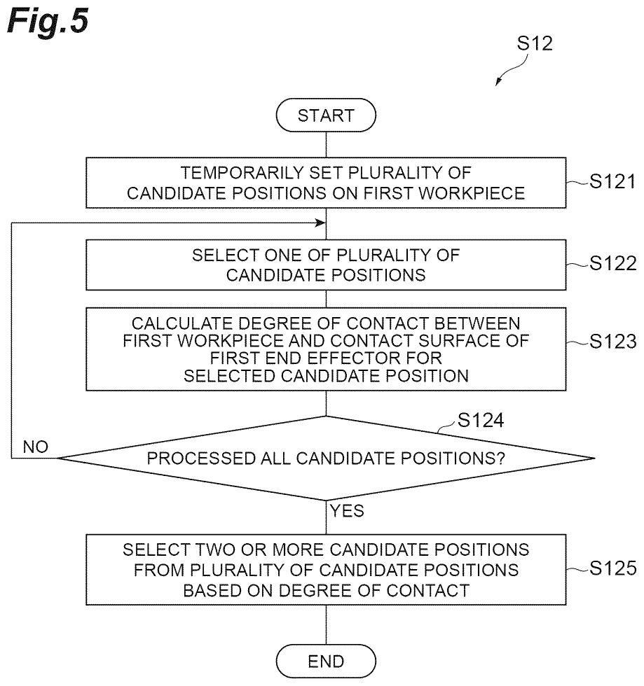

In step S12, the candidate setting unit 12 sets two or more candidate positions on the first workpiece 81 based on the first workpiece model. This process refers to generating a virtual shape of the first workpiece 81 by calculation using the first workpiece model and setting the candidate positions on the virtual shape. An example of this process will be described in detail with reference to FIG. 5. FIG. 5 is a flowchart showing an example of setting the candidate positions.

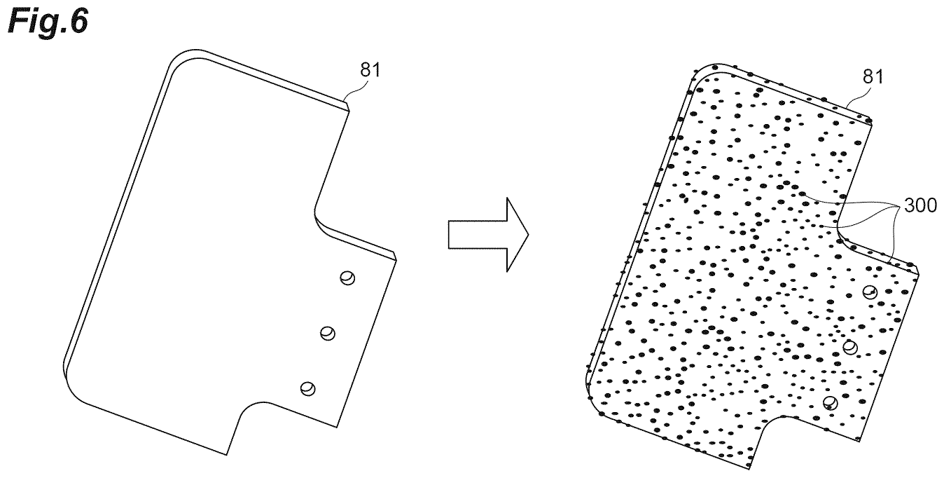

In step S121, the candidate setting unit 12 temporarily sets a plurality of candidate positions on the first workpiece 81. For example, the candidate setting unit 12 sets the candidate positions on each surface of the first workpiece 81 that is a three-dimensional shape. The candidate setting unit 12 may set the plurality of candidate positions randomly or according to a regular pattern such as a grid pattern. FIG. 6 is a diagram showing an example of temporarily set candidate positions. In this example, the candidate setting unit 12 randomly sets candidate positions 300 on the first workpiece 81.

In step S122, the candidate setting unit 12 selects one of the plurality of candidate positions.

In step S123, the candidate setting unit 12 calculates a degree of contact between the first workpiece 81 and a contact surface of the first end effector 21a, for the selected candidate position. The contact surface refers to a surface of the end effector that may come into contact with the workpiece when the end effector holds the workpiece. The contact surface may be a flat surface, may include a curved surface, or may have a more complex shape. The degree of contact refers to an index indicating how much of the contact surface of the end effector contacts the workpiece. The more the contact surface of the end effector contacts the workpiece, the higher the degree of contact. The candidate setting unit 12 generates an imaginary contact surface based on the first robot model, and calculates the degree of contact between the imaginary contact surface and the imaginary first workpiece 81. The candidate setting unit 12 may generate the virtual contact surface so as to be faithful to the shape of the contact surface of the real end effector, or may generate the virtual contact surface in a manner in which the real shape is abstracted.

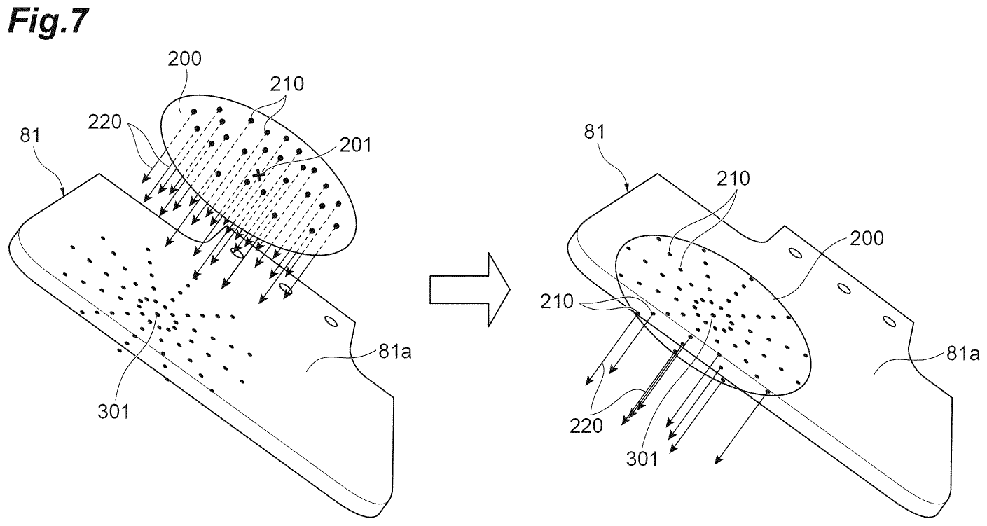

FIG. 7 is a diagram showing an example method of calculating the degree of contact. In this example, the candidate setting unit 12 positions a center 201 of a contact surface 200 to be in contact with the first workpiece 81 at a selected candidate position 301. The candidate setting unit 12 then calculates the degree of contact between the contact surface 200 positioned in that manner and the first workpiece 81. The candidate setting unit 12 generates a plurality of sample points 210 on the contact surface 200 of the first end effector 21a. The candidate setting unit 12 may generate the plurality of sample points 210 according to a regular pattern such as a grid pattern or a radial pattern, or may generate the plurality of sample points 210 at random.

Subsequently, the candidate setting unit 12 brings the contact surface 200 close to the first workpiece 81 along the normal direction of the contact surface 200 to virtually bring the contact surface 200 into contact with the first workpiece 81. The candidate setting unit 12 calculates, for each of the plurality of sample points 210 in that contact state, a distance from the sample point 210 to a surface 81a of the first workpiece 81. To measure the distances, the candidate setting unit 12 uses, for each of the plurality of sample points 210, rays 220, each of which is an imaginary line from the sample point 210 to the surface 81a of the first workpiece 81 along the normal direction of the contact surface 200. The candidate setting unit 12 calculates, for each of the plurality of sample points 210 of the contact surface 200 in contact with the first workpiece 81, the distance from the sample point to the surface 81a of the first workpiece 81. This distance is the length of the ray 220. The length at the sample point 210 in contact with the surface 81a is 0, and the length of the sample point 210 where the ray 220 does not reach the surface 81a is infinite.

The candidate setting unit 12 calculates the degree of contact based on the distance of each of the plurality of sample points. The candidate setting unit 12 may calculate the degree of contact based on a statistical value (e.g., an average) of the distances of the plurality of sample points 210. The candidate setting unit 12 may calculate the degree of contact after replacing the infinite distance with a predetermined value. The candidate setting unit 12 calculates the degree of contact by using a function in which the degree of contact increases as the statistical value decreases. Alternatively, the candidate setting unit 12 may calculate the degree of contact based on an intersection rate that is a rate of the sample points 210 in which the rays 220 intersect with the surface 81a. The candidate setting unit 12 calculates the degree of contact by using a function in which the degree of contact increases as the intersection ratio increases. Since whether the ray 220 intersects with the surface 81a is identified based on the distances, the calculation of the degree of contact based on the intersection ratio is also an example of the calculation of the degree of contact based on the distance. Alternatively, the candidate setting unit 12 may calculate the degree of contact based on both the statistical value of the distances and the intersection ratio. As other examples, the candidate setting unit 12 may calculate the degree of contact based on at least one of the statistical value of the distances and the intersection ratio, and the distance from the selected candidate position to the centroid of the first workpiece 81. For example, the candidate setting unit 12 calculates the degree of contact by further using a function in which the degree of contact increases as the distance to the centroid decreases.

Refer back to FIG. 5. As indicated by step S124, the candidate setting unit 12 calculates the degree of contact for each of the plurality of candidate positions temporarily set. In a case where there is an unprocessed candidate position (NO in step S124), the process returns to step S122. In repeated step S122, the candidate setting unit 12 selects the next candidate position. In repeated step S123, the candidate setting unit 12 calculates the degree of contact between the first workpiece 81 and the contact surface of the first end effector 21a for the selected candidate position.

In a case where all candidate positions have been processed (YES in step S124), the process proceeds to step S125. In step S125, the candidate setting unit 12 selects two or more candidate positions from the plurality of candidate positions based on the degree of contact of each of the plurality of candidate positions. The candidate setting unit 12 may select two or more candidate positions having the degree of contact greater than or equal to a predetermined threshold. Alternatively, the candidate setting unit 12 may select n candidate positions from the top after sorting the candidate positions in descending order of the degree of contact (where n>1). It may be said that such a selection process is a process of narrowing down the plurality of candidate positions temporarily set to candidate positions at which the first end effector 21a is expected to be able to reliably hold the first workpiece 81, that is, candidate positions at which stable holding is expected. The candidate setting unit 12 sets the selected two or more candidate positions for the simulation.

As described with reference to FIG. 5, the candidate setting unit 12 temporarily sets the plurality of candidate positions on the first workpiece 81 based on the first workpiece model. The candidate setting unit 12 then selects the two or more candidate positions from the plurality of candidate positions based on each of the plurality of candidate positions and the shape of the contact surface of the first end effector 21a. The candidate setting unit 12 sets the selected two or more candidate positions for the simulation.

Returning to FIG. 4, in step S13, the simulation unit 13 selects one of the two or more candidate positions narrowed down.

In step S14, the simulation unit 13 executes the simulation based on the selected candidate position. The simulation unit 13 executes the simulation based at least on the first workpiece model and the first robot model. The simulation unit 13 may execute the simulation based further on at least one of the second workpiece model and the second robot model. The simulation unit 13 uses the model data to generate a virtual space corresponding to the real working space 9 and execute the simulation on the virtual space.

The simulation unit 13 virtually executes, by the simulation, a picking process in which the first robot 21 holds the first workpiece 81 at the selected candidate position using the first end effector 21a, and a subsequent process for the first workpiece 81 held at the candidate position.

The simulation unit 13 may execute, as at least part of the subsequent process, a placing process in which the first robot 21 places the first workpiece 81 held by the first end effector 21a at the designated position. In this case, the simulation unit 13 virtually executes the picking process and the placing process. A combination of the picking process and the placing process is also referred to as a pick-and-place process. The simulation unit 13 may execute, as the placing process, a process in which the first robot 21 places the first workpiece 81 held by the first end effector 21a at a designated position on the second workpiece 82. Alternatively, the simulation unit 13 may be executed, as the placing process, a process of placing the first workpiece 81 at a designated position of another object different from the second workpiece 82, such as a workbench or a rack.

The simulation unit 13 may execute, as at least part of the subsequent process, the placing process and an additional process for the first workpiece 81 in a state of being held by the first robot 21 at the designated position. In this case, the simulation unit 13 virtually executes the picking process, the placing process, and the additional process. The additional process may be a process performed by the first robot 21 without using the second robot 22, or may be a process executed by the first robot 21 and the second robot 22 in cooperation with each other. For example, the simulation unit 13 may execute, as the additional process, a cooperative process in which the second robot 22 works on the first workpiece 81 in a state of being held by the first robot 21 at the designated position. The simulation unit 13 may execute, as the additional process, a process in which the second robot 22 fixes the first workpiece 81 onto the second workpiece 82 by a method such as welding or screwing. The simulation unit 13 may execute, as the placing process, a process in which the first robot 21 positions the first workpiece 81 at a designated position set in the air, and may execute, as the cooperative process (additional process), a process in which the second robot 22 receives the first workpiece 81 from the first robot 21 at the designated position. The simulation unit 13 may virtually execute, in the additional process, a work in a plurality of working areas on the first workpiece 81 by the second robot 22. The working area refers to a portion on a workpiece to be processed by a robot. Each working area may be an area defined by a point, a line, or a surface.

As described above, the simulation unit 13 may execute various types of subsequent processes. The subsequent process may include the placing process. Alternatively, the subsequent process may include the placing process and the additional process. Since the additional process may be the cooperative process, the subsequent process may include the placing process and the cooperative process.

In any case, the simulation unit 13 virtually executes the picking process and the subsequent process corresponding to the selected candidate position. In this simulation, the picking process and the subsequent process may or may not be completed. In the present disclosure, “the picking process and the subsequent process may be completed” refers to the fact that a robot is able to continue to take normal postures (i.e., operate normally) in both the picking process and the subsequent process, no interference is detected, and as a result, a series of works from the picking process to the completion of the subsequent process succeed. The interference refers to a phenomenon in which an object contacts or collides with another object. It should be noted that in a case where the robot or the different device attempts to process a workpiece, a contact between the robot or different device and the workpiece is not the interference. In a case where the different device operates, the fact that the different device is able to continue to take normal postures in both the picking process and the subsequent process is also a condition that the picking process and the subsequent process are able to be completed.

The simulation unit 13 stores a result of the simulation in a predetermined storage device such as the memory 162 or the storage 163. For example, the simulation unit 13 may store result data including a pair of the selected candidate position and flag information (result information) indicating whether the picking process and the subsequent process have been able to be completed.

As indicated by step S15, the simulation unit 13 executes the simulation for each of the two or more candidate positions narrowed down. In a case where there is an unprocessed candidate position (NO in step S15), the process returns to step S13. In repeated step S13, the simulation unit 13 selects the next candidate position. In repeated step S14, the simulation unit 13 virtually executes, by the simulation, the picking process and the subsequent process for the selected candidate position.

In a case where all of the two or more candidate positions have been processed (YES in step S15), the process proceeds to step S16. In step S16, the position determination unit 14 determines, as the holding position, one of at least one candidate position that enables the picking process and the subsequent process to be completed in the simulation. That is, the position determination unit 14 determines one of the at least one candidate position having succeeded in the simulation, as the holding position.

The position determination unit 14 refers to the simulation result data and identifies at least one candidate position that enables the picking process and the subsequent process to be completed. For example, the position determination unit 14 may identify at least one candidate position at which the first robot 21 operates normally and no interference is detected in both the picking process and the subsequent process. Alternatively, the position determination unit 14 may identify at least one candidate position at which both the first robot 21 and the second robot 22 operate normally and no interference is detected for both of these two robots in both the picking process and the subsequent process.

The position determination unit 14 may determine the candidate position selected by the user of the control assistance system 1 as the holding position. For example, the position determination unit 14 displays the at least one candidate position identified on a display device (e.g., the monitor 120) of the user. The position determination unit 14 then determines, as the holding position, one candidate position selected by the user from the at least one candidate position.

Alternatively, the position determination unit 14 may automatically determine one of the at least one candidate position identified, as the holding position. For example, the position determination unit 14 may determine, as the holding position, one candidate position having the highest degree of contact among the at least one candidate position.

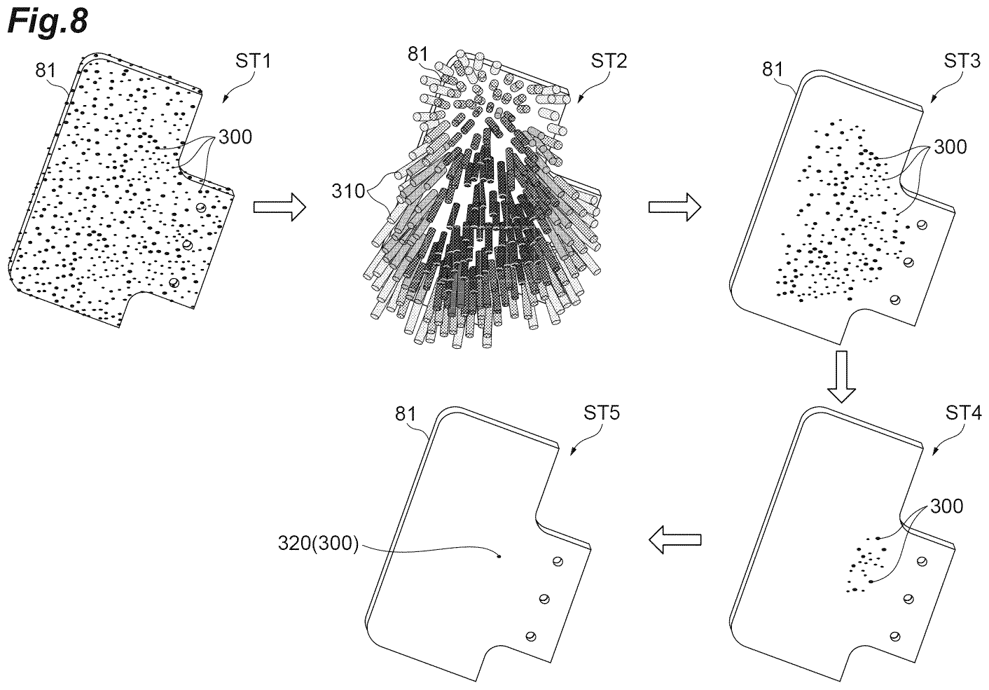

FIG. 8 is a diagram showing an example of a series of processes for determining the holding position with reference to a virtual first workpiece 81. As shown in state ST1, the candidate setting unit 12 sets a plurality of candidate positions 300 on the first workpiece 81 (step S121). The candidate setting unit 12 calculates the degree of contact for each of the plurality of candidate positions 300 (steps S122 to S124). As shown in state ST2, the magnitude of the degree of contact may be visualized by the color density of a bar drawn at each candidate position. In this example, the greater the degree of contact, the darker the color. As shown in state ST3, the candidate setting unit 12 selects two or more candidate positions 300 from the plurality of candidate positions 300 based on the degrees of contact (step S125). In this example, the candidate setting unit 12 has selected the candidate positions 300 having the degree of contacts greater than a predetermined threshold. As shown in state ST4, the simulation unit 13 executes the simulation based on each candidate position selected, and the position determination unit 14 identifies at least one candidate position 300 that enables the picking process and the subsequent process to be completed, based on the result of the simulation (steps S13 to S16). As shown in state ST5, the position determination unit 14 determines one of the at least one the candidate position 300 identified as a holding position 320 based on a user selection or automatically (step S16).

Referring back to FIG. 4, in step S17, the robot control unit 15 controls a real robot based on the holding position.

The robot control unit 15 generates an operation program for controlling the real robot based on the holding position. The robot control unit 15 generates a first operation program for causing the first robot 21 to perform an real picking process for holding the first workpiece 81 at the holding position and a real subsequent process for the first workpiece 81 held at the holding position. In some examples, the robot control unit 15 may generate the first operation program based on the simulation result corresponding to the holding position.

The operation program includes data for controlling the real robot, for example, a path indicating a trajectory of the real robot. The trajectory of a robot refers to a path of motion of the robot or a component thereof. For example, the trajectory of the robot may be a trajectory of a tip portion or an end effector. The first operation program includes at least codes for causing the real first robot 21 to hold the first workpiece 81 at the determined holding position. The first operation program may further include codes for causing the real first robot 21 to perform at least part of the real subsequent process.

The robot control unit 15 may generate a second operation program for controlling the real second robot 22. The second operation program may further include codes for causing the real second robot 22 to perform at least part of the real subsequent process.

The robot control unit 15 controls the real robot based on the operation program. The robot control unit 15 controls the first robot 21 placed in the working space 9 so as to perform a real picking process of holding the first workpiece 81 present in the working space 9 by the first end effector 21a at the holding position. The robot control unit 15 outputs the first operation program to the robot controller 3 to cause the robot controller 3 to control first robot 21. The robot controller 3 operates the first robot 21 based on the first operation program. The robot control unit 15 may output the second operation program to the robot controller 3 to cause the robot controller 3 to control the second robot 22. The robot controller 3 may operate the second robot 22 based on the second operation program.

### Additional Examples

It is to be understood that not all aspects, advantages and features described herein may necessarily be achieved by, or included in, any one particular example. Indeed, having described and illustrated various examples herein, it should be apparent that other examples may be modified in arrangement and detail.

The control assistance system may acquire a workpiece model indicating a workpiece in which a plurality of candidate positions is preset. Alternatively, the control assistance system may output the holding position to another computer system such as a robot control system, and the other computer system may control a real robot based on the holding position. That is, the control assistance system may not include a functional module corresponding to at least one of the candidate setting unit 12 and the robot control unit 15.

In the above examples, the different device is the second robot 22, but the different device may be a device other than the robot, such as a conveyor and an automatic rack.

The control assistance system may virtually execute, through the simulation, the picking process and the subsequent process in a circumstance in which the different device such as the second robot 22 does not exist, to determine the holding position. For example, the control assistance system may simulate a subsequent process performed by a robot alone, such as the first robot 21 alone.

The hardware configuration of the system is not limited to a manner in which each functional module is realized by executing a program. For example, at least part of the above-described functional modules may be configured by a logic circuit specialized for the function(s), or may be configured by an application specific integrated circuit (ASIC) in which the logic circuits are integrated.

The processing procedure of the method executed by the at least one processor is not limited to the above examples. For example, some of the steps or processes described above may be omitted, or the steps may be executed in a different order. In addition, any two or more of the above-described steps may be combined, or some of the steps may be modified or deleted. Alternatively, another step may be executed in addition to the above-described steps.

When a magnitude relationship between two numerical values is compared in a computer system or a computer, either of two criteria of “equal to or greater than” and “greater than” may be used, and either of two criteria of “equal to or less than” and “less than” may be used.

### Appendix

As can be understood from the various examples described above, the present disclosure includes the following aspects.

(Appendix 1) A control assistance system comprises:
a simulation unit configured to virtually execute, for each of two or more candidate positions that are two or more candidates for a holding position on a workpiece to be held by an end effector of a robot, a picking process in which the end effector holds the workpiece at the candidate position and a subsequent process for the workpiece held at the candidate position, by a simulation based on a workpiece model indicating a shape of the workpiece and a robot model indicating the robot having the end effector; and
a determination unit configured to determine, as the holding position, one of at least one candidate position that enables the picking process and the subsequent process to be completed in the simulation.

(Appendix 2) The control assistance system according to appendix 1,
wherein the subsequent process includes a placing process in which the robot places the held workpiece at a designated position, and an additional process for the workpiece in a state of being held by the robot at the designated position, and
wherein the simulation unit is configured to virtually execute the picking process, the placing process, and the additional process.

(Appendix 3) The control assistance system according to appendix 1 or 2,
wherein the simulation unit is configured to virtually execute, by the simulation based further on a device model indicating a different device different from the robot, a process performed by the robot and the different device in cooperation with each other on the workpiece held at the candidate position, as the subsequent process, and
wherein the determination unit is configured to identify the at least one candidate position that enables the picking process and the subsequent process to be completed without detecting interference for both the robot and the different device.

(Appendix 4) The control assistance system according to appendix 3,
wherein the different device is a different robot, and
wherein the simulation unit is configured to virtually execute the subsequent process including a placing process in which the robot places the held workpiece at a designated position and a cooperative process in which the different robot works on the workpiece in a state of being held by the robot at the designated position.

(Appendix 5) The control assistance system according to appendix 4, wherein the simulation unit is configured to virtually execute a work in a plurality of working areas on the workpiece by the different robot, in the cooperative process.

(Appendix 6) The control assistance system according to appendix 4 or 5, wherein the simulation unit is configured to:
virtually execute, as the placing process, a process in which the robot places the held workpiece at the designated position on a different workpiece; and
virtually execute, as the cooperative process, a process in which the different robot fixes the workpiece on the different workpiece.

(Appendix 7) The control assistance system according to any one of appendices 1 to 6, further comprising a robot control unit configured to control a robot placed in a real working space so as to perform a real picking process of holding the workpiece present in the real working space at the holding position by the end effector.

(Appendix 8) The control assistance system according to any one of appendices 1 to 7, further comprising:
an acquisition unit configured to acquire, in a case where the workpiece to be held by the end effector is designated, the workpiece model of the designated workpiece; and
a setting unit configured to the two or more candidate positions based on the acquired workpiece model.

(Appendix 9) The control assistance system according to appendix 8, wherein the setting unit is configured to:
temporarily set a plurality of the candidate positions on the workpiece based on the workpiece model;
select the two or more candidate positions from the plurality of candidate positions based on each of the plurality of candidate positions and a shape of a contact surface of the end effector capable of contacting the workpiece; and
set the selected two or more candidate positions for the simulation.

(Appendix 10) The control assistance system according to appendix 9, wherein the setting unit is configured to:
calculate, for each of the plurality of candidate positions, a degree of contact between the contact surface and the workpiece in a case where a center of the contact surface in contact with the workpiece is positioned at the candidate position; and
select the two or more candidate positions from the plurality of candidate positions based on the degree of contact of each of the plurality of candidate positions.

(Appendix 11) The control assistance system according to appendix 10, wherein the setting unit is configured to, for each of the plurality of candidate positions:
generate a plurality of sample points on the contact surface;
calculate, for each of the plurality of sample points, a distance from the sample point to a surface of the workpiece; and
calculate the degree of contact based on the distance of each of the plurality of sample points.

(Appendix 12) The control assistance system according to any one of appendices 1 to 11, wherein the determination unit is configured to:
display the at least one candidate position that enables the subsequent process to be completed in the simulation, on a display device of a user; and
determine one candidate position selected by the user from the at least one candidate position, as the holding position.

(Appendix 13) A control assistance method executable by a control assistance system including at least one processor, the method comprising:
virtually executing, for each of two or more candidate positions that are two or more candidates for a holding position on a workpiece to be held by an end effector of a robot, a picking process in which the end effector holds the workpiece at the candidate position and a subsequent process for the workpiece held at the candidate position, by a simulation based on a workpiece model indicating a shape of the workpiece and a robot model indicating the robot having the end effector; and
determining, as the holding position, one of at least one candidate position that enables the picking process and the subsequent process to be completed in the simulation.

(Appendix 14) A control assistance program causing a computer to execute:
virtually executing, for each of two or more candidate positions that are two or more candidates for a holding position on a workpiece to be held by an end effector of a robot, a picking process in which the end effector holds the workpiece at the candidate position and a subsequent process for the workpiece held at the candidate position, by a simulation based on a workpiece model indicating a shape of the workpiece and a robot model indicating the robot having the end effector; and
determining, as the holding position, one of at least one candidate position that enables the picking process and the subsequent process to be completed in the simulation.

According to appendices 1, 13 and 14, not only the picking process but also the subsequent processes are virtually executed for each of two or more candidate positions, and a candidate position that enables both the processes to be completed is determined as the holding position. Since the effective holding position is determined not only in the picking process but also in the subsequent processes, it is not necessary to change the holding position between the two processes. That is, this mechanism may be able to determine the holding position of the workpiece that contributes to an efficient operation of the robot.

According to appendix 2, not only the pick-and-place process but also the subsequent processes are virtually executed for each of two or more candidate positions, and a candidate position that enables both the processes to be completed is determined as the holding position. Since the effective holding position is determined not only in the process of placing the workpiece at the designated position but also in the subsequent process, it is not necessary to change the holding position during the series of processes. That is, this mechanism may be able to determine the holding position of the workpiece that contributes to an efficient operation of the robot.

According to appendix 3, the simulation is executed, including a motion of the different device cooperating with the robot that performs the picking process, and the holding position that enables the picking process and the subsequent process to be completed is finally determined. This mechanism may be able to determine a position at which a workpiece should be held in a process performed by a plurality of devices.

Since a process by a plurality of robots may be complicated, it is not easy to manually determine the holding position in this process. According to appendix 4, the simulation is executed, including a motion of the different robot cooperating with the robot that performs the pick-and-place process, and the holding position that enables the pick-and-place process and the cooperative process to be completed is finally determined. By using this mechanism, a series of complicated tasks by a plurality of robots may be realized, and the holding position on the workpiece that contributes to an efficient operation of the robots in the complicated tasks may be determined.

In a case where multiple robots process multiple working areas on a workpiece, more factors need to be considered than a process related to a single robot or a single working area. According to appendix 5, the holding position at which a plurality of robots cooperates to process a plurality of working areas on a workpiece is finally determined. Therefore, even in such a complicated case, the holding position on the workpiece that contributes to an efficient operation of the robot may be determined.

According to appendix 6, even in a complicated case where a plurality of robots cooperates to fix a workpiece to another workpiece, the holding position on the workpiece that contributes to an efficient operation of the robot may be determined.

According to appendix 7, since a position at which the workpiece is to be held by the end effector may be easily determined, the effort for more efficiently controlling a real robot may be reduced accordingly.

According to appendix 8, the workpiece model of the workpiece is acquired in response to the designation of the workpiece, and the two or more candidate positions are set based on the workpiece model. By this mechanism, even in a case where the robot processes various workpieces, the holding position that enables an efficient operation by the robot may be determined for each workpiece.

According to appendix 9, the plurality of candidate positions is temporarily set at first, the number of candidate positions is then narrowed down based on the shape of the contact surface of the end effector, and the simulation is executed by the remaining candidate positions. By reducing the number of candidate positions to be simulated, the total execution time of the simulation may be reduced, and thus the holding position may be determined more quickly.

According to appendix 10, since the degree of contact between the contact surface of the end effector and the workpiece is considered, a candidate position expected to be able to reliably hold the workpiece by the end effector, that is, a candidate position expected to be able to reliably perform at least the picking process may be selected. Therefore, the simulation for the two or more candidate positions may be execute efficiently and the holding position may be determined more quickly.

According to appendix 11, the degree of contact between the contact surface and the workpiece may be calculated more accurately by considering the distance from each sample point on the contact surface in contact with the workpiece to the surface of the workpiece.

According to appendix 12, by preparing a mechanism that leaves the final determination of the holding position to the user, the holding position may be determined in a manner that also reflects the user's expertise and experience. Since only the candidate positions at which the workpiece may be held and the subsequent process may be reliably performed are presented to the user, the effort of the user to determine the holding position may be reduced.

What is claimed is:

1. A control assistance system comprising circuitry configured to:
acquire a workpiece model indicating a shape of a workpiece;
acquire a robot model indicating a robot having an end effector for holding the workpiece;
set, on the workpiece, two or more candidate positions that are two or more candidates for a holding position on the workpiece to be held by the end effector, based on the workpiece model;
virtually execute, for each of the two or more candidate positions, a picking process in which the end effector holds the workpiece at the candidate position and a subsequent process for the workpiece held at the candidate position, by a simulation based on the workpiece model and the robot model;
determine, as the holding position, one of at least one candidate position among the two or more candidate positions, wherein the at least one candidate position enables the picking process and the subsequent process to be completed in the simulation; and
control the robot placed in a real working space, based on the holding position.

2. The control assistance system according to claim 1,
wherein the subsequent process includes a placing process in which the robot places the held workpiece at a designated position, and an additional process for the workpiece in a state of being held by the robot at the designated position, and
wherein the circuitry is configured to virtually execute the picking process, the placing process, and the additional process.

3. The control assistance system according to claim 1, wherein the circuitry is configured to identify at least one candidate position where the robot operates normally and no interference is detected, as the at least one candidate position that enables the picking process and the subsequent process to be completed.

4. The control assistance system according to claim 1, wherein the circuitry is configured to generate a virtual shape of the workpiece based on the workpiece model, and set the two or more candidate positions on the virtual shape, thereby setting the two or more candidate positions on the workpiece.

5. The control assistance system according to claim 1, wherein the circuitry is configured to:
acquire a device model indicating a different device different from the robot;
virtually execute, as the subsequent process, a process performed by the robot and the different device in cooperation with each other on the workpiece held at the candidate position, by the simulation based further on the device model; and
identify the at least one candidate position that enables the picking process and the subsequent process to be completed without detecting interference for both the robot and the different device.

6. The control assistance system according to claim 5,
wherein the different device is a different robot, and
wherein the circuitry is configured to virtually execute the subsequent process including a placing process in which the robot places the held workpiece at a designated position and a cooperative process in which the different robot works on the workpiece in a state of being held by the robot at the designated position.

7. The control assistance system according to claim 6, wherein the circuitry is configured to virtually execute a work in a plurality of working areas on the workpiece by the different robot, in the cooperative process.

8. The control assistance system according to claim 7, wherein the circuitry is configured to:
virtually execute, as the placing process, a process in which the robot places the held workpiece at the designated position on a different workpiece; and
virtually execute, as the cooperative process, a process in which the different robot fixes the workpiece on the different workpiece.

9. The control assistance system according to claim 1, wherein the circuitry is configured to control the robot placed in the real working space so as to perform a real picking process of holding the workpiece present in the real working space at the holding position by the end effector.

10. The control assistance system according to claim 9, wherein the circuitry is configured to control the robot so as to perform the real picking process and a real subsequent process on the workpiece held at the holding position.

11. The control assistance system according to claim 1, wherein the circuitry is configured to acquire, in a case where the workpiece to be held by the end effector is designated by a user, the workpiece model of the designated workpiece.

12. The control assistance system according to claim 1, wherein the circuitry is configured to acquire, in a case where the robot is designated by a user, the robot model of the designated robot.

13. The control assistance system according to claim 1, wherein the circuitry is configured to:
temporarily set a plurality of the candidate positions on the workpiece based on the workpiece model;
select the two or more candidate positions from the plurality of candidate positions based on each of the plurality of candidate positions and a shape of a contact surface of the end effector capable of contacting the workpiece; and
set the selected two or more candidate positions for the simulation.

14. The control assistance system according to claim 13, wherein the circuitry is configured to:
calculate, for each of the plurality of candidate positions, a degree of contact between the contact surface and the workpiece, wherein the degree of contact is an index indicating how much of the contact surface contacts the workpiece; and
select the two or more candidate positions from the plurality of candidate positions based on the degree of contact of each of the plurality of candidate positions.

15. The control assistance system according to claim 14, wherein the circuitry is configured to calculate, for each of the plurality of candidate positions, the degree of contact in a case where a center of the contact surface in contact with the workpiece is positioned at the candidate position.

16. The control assistance system according to claim 14, wherein the circuitry is configured to, for each of the plurality of candidate positions:
generate a plurality of sample points on the contact surface;
calculate, for each of the plurality of sample points, a distance from the sample point to a surface of the workpiece; and
calculate the degree of contact based on the distance of each of the plurality of sample points.

17. The control assistance system according to claim 14, wherein the circuitry is configured to automatically determine one of the at least one candidate position as the holding position based on the degree of contact of each of the at least one candidate position that enables the picking process and the subsequent process to be completed in the simulation.

18. The control assistance system according to claim 1, wherein the circuitry is configured to:
display the at least one candidate position that enables the picking process and the subsequent process to be completed in the simulation, on a display device of a user; and
determine one candidate position selected by the user from the at least one candidate position, as the holding position.

19. A processor-executable method comprising:
acquiring a workpiece model indicating a shape of a workpiece;
acquiring a robot model indicating a robot having an end effector for holding the workpiece;
setting, on the workpiece, two or more candidate positions that are two or more candidates for a holding position on the workpiece to be held by the end effector, based on the workpiece model;
virtually executing, for each of the two or more candidate positions, a picking process in which the end effector holds the workpiece at the candidate position and a subsequent process for the workpiece held at the candidate position, by a simulation based on the workpiece model and the robot model;
determining, as the holding position, one of at least one candidate position among the two or more candidate positions, wherein the at least one candidate position enables the picking process and the subsequent process to be completed in the simulation; and
controlling the robot placed in a real working space, based on the holding position.

20. A non-transitory computer-readable storage medium storing processor-executable instructions to:
acquire a workpiece model indicating a shape of a workpiece;
acquire a robot model indicating a robot having an end effector for holding the workpiece;
set, on the workpiece, two or more candidate positions that are two or more candidates for a holding position on the workpiece to be held by the end effector, based on the workpiece model;
virtually execute, for each of the two or more candidate positions, a picking process in which the end effector holds the workpiece at the candidate position and a subsequent process for the workpiece held at the candidate position, by a simulation based on the workpiece model and the robot model;
determine, as the holding position, one of at least one candidate position among the two or more candidate positions, wherein the at least one candidate position enables the picking process and the subsequent process to be completed in the simulation; and
control the robot placed in a real working space, based on the holding position.
